(19) United States
(12) Patent Application Publication
(10) Pub. No.: US 2022/0067719 A1
(43) Pub. Date: Mar. 3, 2022

(54) SYSTEMS AND METHODS FOR LEVERAGING REAL-TIME PAYMENTS FOR IDENTITY VALIDATION IN NON-FINANCIAL INTERACTIONS

(71) Applicant: Wells Fargo Bank, N.A., San Francisco, CA (US)

(72) Inventors: Frank A. DiGangi, Statesville, NC (US); Carrie Anne Hanson, Charlotte, NC (US); Daniel Alexander David, Charlotte, NC (US); Loftlon Lindsey Worth, Huntersville, NC (US)

(21) Appl. No.: 17/006,205

(22) Filed: Aug. 28, 2020

(51) Int. Cl. G06Q 20/38; G06Q 20/42; G06Q 20/40

(52) U.S. Cl. CPC G06Q 20/3821; G06Q 20/4014; G06Q 20/42

(57) ABSTRACT

In an embodiment, a financial-institution system receives an identity-validation transmission via a real-time-payment platform. The identity-validation transmission is received in association with a first deposit account that is held at a financial institution that is associated with the financial-institution system. The identity-validation transmission was sent via the real-time-payment platform in association with a second deposit account. The identity of an account holder of the second deposit account is validated based at least in part on the identity-validation transmission.

### TECHNICAL FIELD

The present disclosure relates to financial institutions, real-time payments, and identity validation, and more particularly to systems and methods for leveraging real-time payments for identity validation in non-financial interactions.

### BACKGROUND

In today's modern society, people engage in all sorts of interactions, some of which are primarily financial in nature, some of which are not. Regardless of the type of interaction, there are many times in which it is important to one or more parties to a given interaction, transaction, and/or the like to be able to validate (i.e., confirm, verify, and/or the like) that a certain person (e.g., another party to the interaction, transaction, etc.) is who they assert they are, owns what they assert they own, and so forth.

### BRIEF DESCRIPTION OF THE DRAWINGS

A more detailed understanding may be had from the following description, which is presented by way of example in conjunction with the following drawings, in which like reference numerals are used across the drawings in connection with like elements.

FIG. 1 illustrates an example communication context that includes an example real-time-payment platform and multiple example financial institutions and associated financial-institution systems, in accordance with at least one embodiment.

FIG. 2 illustrates an example method that may be performed by an example one of the financial-institution systems of FIG. 1, in accordance with at least one embodiment.

FIG. 3 illustrates a first example message flow involving an example group of entities from the communication context of FIG. 1, in accordance with at least one embodiment.

FIG. 4 illustrates a second example message flow involving an example group of entities from the communication context of FIG. 1, in accordance with at least one embodiment.

FIG. 5 illustrates a third example message flow involving an example group of entities from the communication context of FIG. 1, in accordance with at least one embodiment.

FIG. 6 illustrates an example network arrangement that may be employed by one or more of the example financial institutions of FIG. 1, in accordance with at least one embodiment.

FIG. 7 illustrates an example computer system within which a set of instructions may be executed for causing the computer system to perform any one or more of the methodologies discussed herein.

FIG. 8 illustrates an example software architecture in accordance with which one or more embodiments of the present disclosure may be implemented.

### DETAILED DESCRIPTION

As mentioned above, there are numerous situations in which validation of identity is important. That is, it is often important that a person, a company, an automated system, and/or the like be able to validate that a person is who they say they are, owns what they say they own, and so forth. Many of these situations involve interactions and transactions that are primarily financial in nature, such as opening a checking account, signing legal documents (e.g., mortgage documents), accessing safety-deposit boxes, and the like. There are also, however, many interactions—that are referred to herein as non-financial interactions—that are not primarily financial in nature, although in many such cases there is money involved to some extent. For example, the act of a rideshare-service driver identifying and picking up a rideshare-service passenger is not inherently financial in nature even though the passenger pays for the ensuing ride. Similarly, an owner of a house validating that a given person that is, e.g., standing on the porch of that house, ready and wanting to go in is the same person that paid to rent the house is not inherently a financial interaction in spite of the fact that money is of course involved in the rental. It should be explicitly understood, then, that the presence and/or exchange of money in some capacity in connection with a given interaction does not disqualify that interaction from being a non-financial interaction as that term is used in the present disclosure.

Among other inspirations and motivations, embodiments of the present disclosure arose in part from the realization and recognition that real-time-payment platforms (RTP platforms) and their accompanying RTP payments and RTP messages are a fast and secure mechanism that could be used to validate identity, due at least in part to the rigorous identification-validation process that financial institutions typically carry out in connection with a prospective customer opening one or more deposit accounts. These identification-validation processes are often carried out by financial institutions in order to comply with various regulatory requirements that pertain to institutions that maintain deposit accounts for customers, as well as for risk mitigation as a general matter.

A typical identification-validation process in this context often requires the presentation by the prospective customer of documents such as a passport, a driver's license, a social-security card, a birth certificate, one or more other government IDs, one or more utility bills that are addressed to the customer at a residence that matches an address listed on a government-issued ID, mortgage documents that match such an address, one or more other pieces of mail that match such an address, and/or the like.

Embodiments of the present disclosure leverage these identification-validation processes as well as the speed, security, and reliability of RTP platforms by utilizing RTP payments and/or RTP messages to validate identity in other contexts. Thus, provided herein are embodiments of systems and methods for leveraging real-time payments and/or messages for identity validation in non-financial interactions. As used herein, validation of identity can include validation of ownership of certain property. And while examples that involve non-financial interactions are primarily discussed in the present disclosure, it is explicitly noted and contemplated that embodiments of the present disclosure could also be used to validate identity in connection with interactions, transactions, and/or the like that are primarily financial in nature.

As used herein, real-time payments (i.e., RTP payments) are payments that are made from one RTP endpoint to another RTP endpoint by way of an RTP platform, where each RTP endpoint is, for example, a deposit account such as a checking account, a savings account, a money-market account, or another type of account in which money can reside. In general, RTP platforms provide real-time payments and messages for their member financial institutions (e.g., banks) and optionally for one or more third-party payment-processing entities. RTP platforms are also known and referred to by other names such as RTP networks, RTP systems, and the like. Moreover, the various RTP platforms that are available to financial institutions are often collectively referred to as the RTP rail, the RTP payment rail, and the like.

Examples of RTP platforms include the Real Time Payments (RTP) Network that is operated by The Clearing House and based in the United States (U.S.), the Zelle network that is operated by Early Warning Services and also based in the U.S., the FedNow service that is operated by the Federal Reserve in the U.S., the Faster Payments Service (FPS) that is based in the United Kingdom (U.K.), an RTP network that was built by NPP Australia Ltd and that is backed by the Reserve Bank of Australia's Fast Settlement Service (FSS), and the like. RTP platforms such as these enable parties to quickly and securely clear transactions between financial accounts, and also to quickly and securely pass messages, files, attachments (e.g., invoices), and/or other data between financial accounts as well.

Any party to a given RIP payment or other RTP message can be an individual or an organization (e.g., a business) or any other type of financial-account holder. As a general matter, RTP platforms offer more convenience and security than wallet-based networks, which typically require users to maintain individual accounts with those payment networks, and where establishing those accounts often includes the users sharing their deposit-account information (e.g., routing number and account number) with the third-party operator of the payment network. Furthermore, RTP platforms offer more convenience and risk avoidance than the Automated. Clearing House (ACH) network in which instant (or even quite rapid) payments or even funds verification is not available, and in which recipients accordingly assume an increased risk that payments that are directed to them will fail.

Thus, RTP payments, which, as the term is used herein, refers generally to payments made via any RTP platform, are payments that are made from one financial account to another, and that are delivered and settled (and the associated funds therefore become available to recipients) in what is referred to in the industry as “real time.” This does not necessarily mean instantaneously, as payments can take anywhere from less than a second to a few seconds to perhaps as many as fifteen or thirty seconds or more.

In some cases, RTP platforms tokenize the deposit accounts of users, such that a sender can address an RTP payment or RTP message to a token that serves as a proxy for the recipient's account. Such tokens can take the form of usernames, email addresses, phone numbers (e.g., mobile numbers), other alphabetic identifiers, other numeric identifiers, other alphanumeric identifiers, and/or the like. In some cases, the senders of RTP payments address those payments to a 2-tuple of the routing number of the recipient's financial institution and the recipient's account number at that financial institution.

Some RTP platforms, such as the RTP Network, enable the association of fund transfers (a.k.a. payments, credit transfers, etc.) with order numbers and/or other identifiers, and further enable sets of RTP payments and/or RTP messages and responses thereto to be associated with one another as part of a communication thread. In the case of many RTP platforms, member institutions reconcile funds with one another one or more times (e.g., three times) each day or at least each business day. All RTP payments and RTP messages are typically sent with end-to-end encryption between financial institutions over a secure connection. Such RTP payments and other RTP messages typically comply with standards promulgated by the International Organization for Standardization (ISO) 20022 Real-Time Payments Group (RTPG).

In a typical example, a sender of an RIP payment (or RIP message, though an RTP payment is described here by way of example) may instruct their financial institution (via, e.g., a web interface, a mobile-banking app from their smartphone, and/or the like) to send the RTP payment to a recipient's account at another financial institution. The sender's financial institution may then send a credit transfer in the amount of the payment via an RTP platform to the recipient's financial institution. The payment may then show up in the recipient's account at the recipient's financial institution, and the name of the business or person that sent the payment may appear in a transaction description that is associated in the recipient's account with that payment.

The funds are typically immediately available to the recipient, as guaranteed to the recipient's financial institution by the sender's financial institution, and batch reconciliation (e.g., net reconciliation) between the two financial institutions may occur at a slightly later time, usually later that day or relatively early the next day (or business day). Typically, the recipient's financial institution sends an immediate confirmation of receipt of the RTP payment to the sender's financial institution, and may also send a notification to, e.g., a mobile-banking app on a smartphone of the recipient, an email notification to an email address associated with the recipient, and/or the like. RTP messages (i.e., non-payment RTP messages) operate in substantially the same way, other than there is of course no money moving in connection with such RTP messages.

Embodiments of the present disclosure leverage RTP platforms, including the RTP payments and RTP messages and additional data that can be transmitted via such platforms, to assist people, organizations (e.g., businesses), applications, automated systems, and/or the like in validating the identity of a particular person at a particular time. Some embodiments relate also or instead to validating that a particular person owns a particular property item, such as a house, a car, a boat, and/or the like.

As a non-exhaustive list of examples, a person's identity can be validated in connection with various embodiments to facilitate that person being picked up as a rideshare passenger, picking up another person as a rideshare driver, renting a home from someone, renting a home to someone, receiving a service, performing a service, receiving a package and/or other goods, dropping off a package and/or other goods, accessing a controlled resource (e.g., a building), and/or the like. Various embodiments provide, via an RTP platform, Boolean indicators of identity and/or ownership validation (or non-validation), confidence scores with respect to identity and/or ownership, and/or simply information that a recipient of such information can use to make their own identity-validation and/or ownership-validation determination.

One embodiment takes the form of a method that includes receiving, by a financial-institution system that includes at least one hardware processor, an identity-validation transmission via a real-time-payment platform. The identity-validation transmission is received in association with a first deposit account that is held at a financial institution that is associated with the financial-institution system. The identity-validation transmission had been sent via the real-time-payment platform in association with a second deposit account. The method also includes validating an identity of an account holder of the second deposit account based at least in part on the identity-validation transmission.

As described herein, one or more embodiments of the present disclosure take the form of methods that include multiple operations. One or more other embodiments take the form of systems (e.g., financial-institution systems) that include at least one hardware processor and that also include one or more computer-storage media containing instructions executable by the at least one hardware processor for causing the at least one hardware processor to perform multiple operations (that may or may not correspond to operations performed in a herein-disclosed method embodiment). Still one or more other embodiments take the form of one or more computer-storage media containing instructions executable by at least one hardware processor (of, e.g., a financial-institution system) for causing the at least one hardware processor to perform multiple operations (that, again, may or may not correspond to operations performed in a herein-disclosed method embodiment and/or operations performed by a herein-disclosed system embodiment).

Furthermore, a number of variations and permutations of the above-listed embodiments are described herein, and it is expressly noted that any variation or permutation that is described in this disclosure can be implemented with respect to any type of embodiment. For example, a variation or permutation that is primarily described in this disclosure in connection with a method embodiment could just as well be implemented in connection with a system embodiment and/or a non-transitory-computer-readable-storage-media embodiment. Furthermore, this flexibility and cross-applicability of embodiments is present in spite of any slightly different language (e.g., processes, methods, methodologies, steps, operations, functions, and/or the like) that is used to describe and/or characterize such embodiments and/or any element or elements thereof.

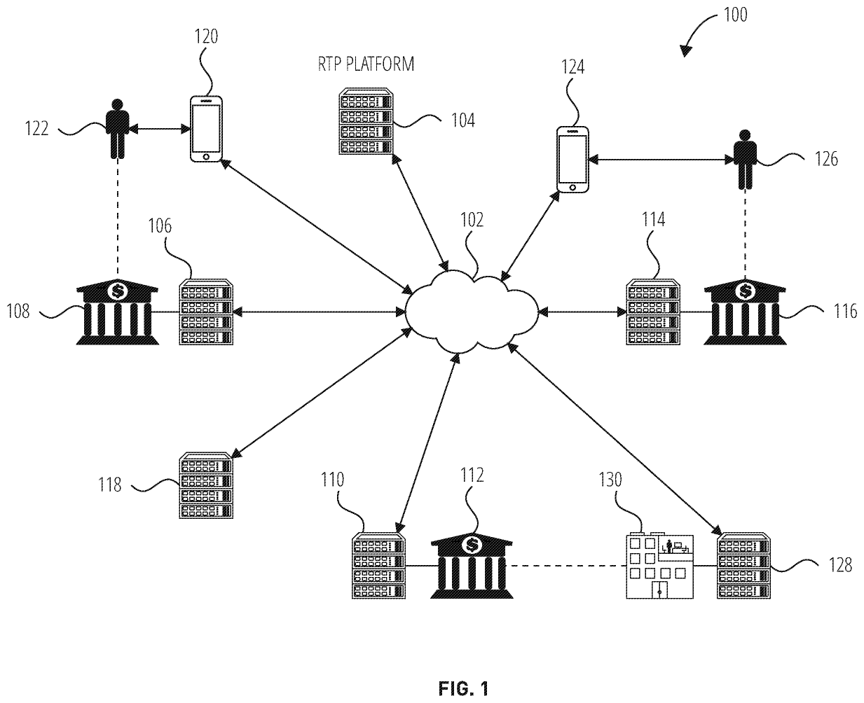

FIG. 1 illustrates an example communication context 100 in which at least one embodiment can be carried out. The communication context 100 is provided by way of example and not limitation, as different communication contexts, network arrangements, and/or the like could be implemented in connection with various different embodiments. Furthermore, there could be different numbers, types, and/or arrangements of devices, systems, networks, and/or the like as compared with what is depicted in the example communication context 100 of FIG. 1.

In the example communication context 100, a number of different devices, systems, and the like are communicatively connected with a network 102 via respective communication links. These include an RTP platform 104, a financial-institution system 106 that is operated by a financial institution 108, a financial-institution system 110 that is operated by a financial institution 112, a financial-institution system 114 that is operated by a financial institution 116, a server system 118, a mobile device 120 that is associated with a person 122, a mobile device 124 that is associated with a person 126, and a corporate system 128 that is operated by a company 130.

As indicated by the dotted lines in FIG. 1, the person 122 has a deposit account with the financial institution 108, the person 126 has a deposit account with the financial institution 116, and the company 130 has a deposit account with the financial institution 112. By way of example and not limitation, these deposit accounts are checking accounts.

The RTP platform 104 could represent any of the RTP platforms mentioned in present disclosure or any other suitable RTP platform. Each of the RIP platform 104, the financial-institution system 106, the financial-institution system 110, the financial-institution system 114, the server system 118, the corporate system 128, and any other server system mentioned herein could be realized as or at least include a single server, a system of servers located in a given geographical area, a distributed group of servers residing across any number of geographic and/or network-topology locations, and/or the like. Furthermore, the mobile device 120 and the mobile device 124 are devices that are shown by way of example, as the person 122 and/or the person 126 may use any suitable device such as a tablet, a laptop computer, a desktop computer, and/or the like to access and manage their respective accounts at the financial institutions with which they respectively do business.

Any one or more of the financial institution 108, the financial institution 112, and the financial institution 116 could be any suitable type of online and/or brick-and-mortar financial institution that maintains deposit accounts for customers. In the depicted example, the financial institution 108, the financial institution 112, and the financial-institution system 114 are all separate and distinct financial institutions that are each a member institution of the RTP platform 104.

Any one or more of the financial-institution system 106, the financial-institution system 110, and the financial-institution system 114 could host a web-server application that provides an online-banking portal that can be accessed by devices such as the mobile device 120 and the mobile device 124. Furthermore, any one or more of the financial institution 108, the financial institution 112, and the financial institution 116 may offer a mobile app for download, installation, and execution by such devices, where that mobile app provides its user with access to one or more accounts held with the corresponding financial institution. Desktop applications could be employed as well, among other possible example mechanisms via which users could manage their accounts and take advantage of embodiments of the present disclosure.

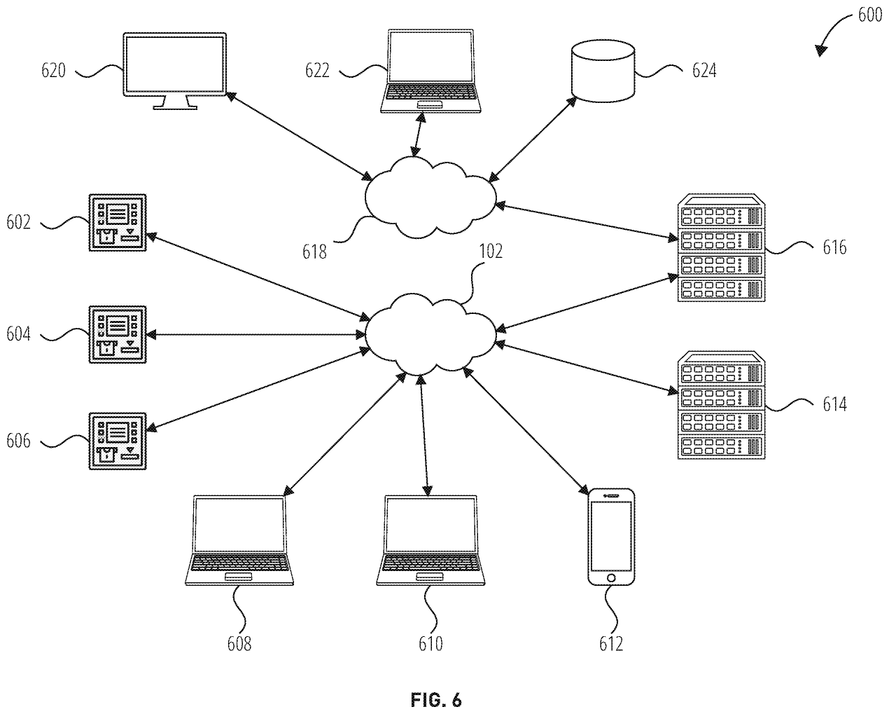

The network 102 could be a data-communication network such as, including, and/or in communication with the Internet. The network 102 could operate according to a suite of communication protocols such as the Transmission Control Protocol (TCP) over the Internet Protocol (IP) (collectively, TCP/IP), the User Datagram Protocol (UDP) over IP (UDP/IP), and/or others. Furthermore, as described more fully below in connection with FIG. 6, any one or more of the financial institutions (e.g., the financial institution 108) could operate a private IP network that is communicatively connected to the network 102 via one or more devices that perform network-access-server (NAS) functions, gateway services, firewall protections, and/or the like for the respective financial institution. Any devices and/or systems that are communicatively connected to the network 102 could communicate with any one or more other devices and/or systems via a virtual private network (VPN) and/or another type of secure-tunneling communication protocol, connection, and/or the like.

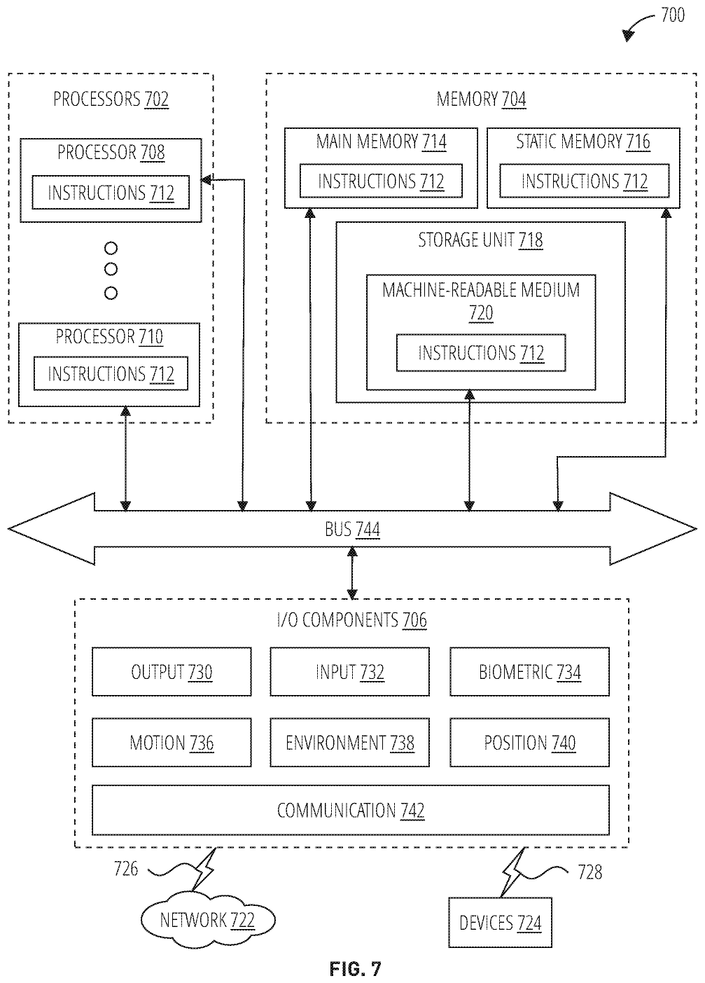

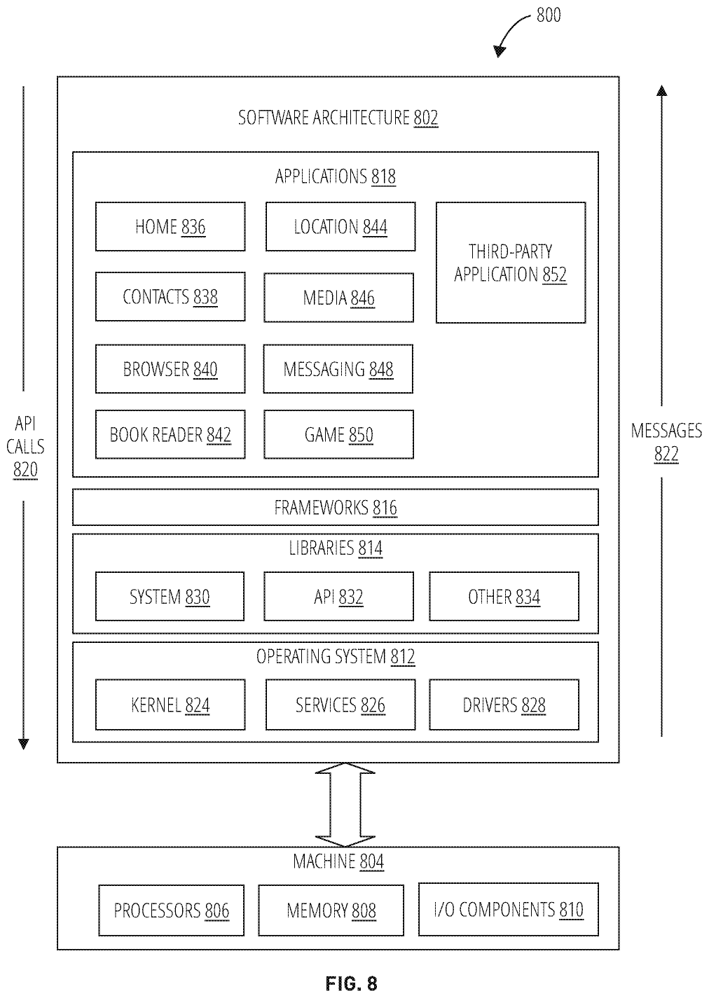

Any of the devices, systems, and the like that are depicted in FIG. 1 and/or in any of the other figures could have a hardware architecture similar to that described below in connection with the example computer system 700 of FIG. 7 and could contain and execute software having a software architecture similar to that described below in connection with the example software architecture 802 of FIG. 8. Moreover, any of the communication links depicted in FIG. 1 and/or in any of the other figures could be or include one or more wired-communication links (e.g., Ethernet, fiber optic, Universal Serial Bus (USB), and/or the like) and/or one or more wireless-communication links (e.g., Wi-Fi, LTE, NFC, Bluetooth, Bluetooth Low Energy, and/or the like). Any one or more of the communication links could include one or more intermediate devices such as one or more routers, bridges, servers, access points, base stations, and/or the like. Additionally, any communication link could include one or more VPNs and/or other tunneling-type connections.

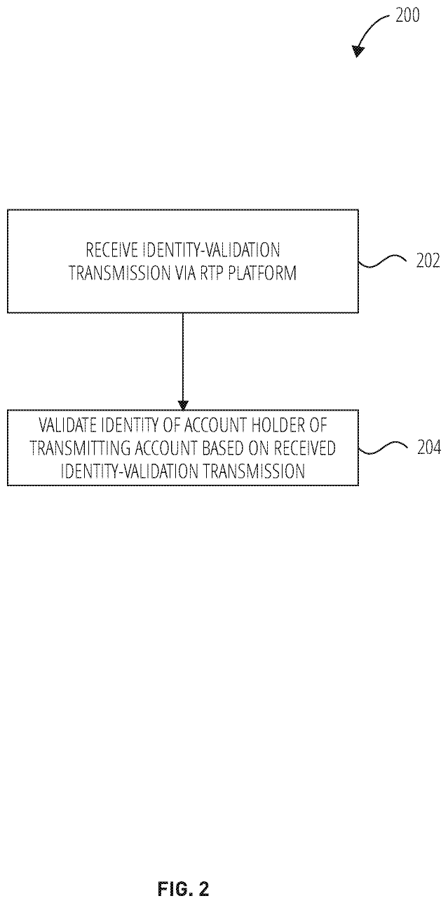

FIG. 2 illustrates an example method that may be performed by an example one of the financial-institution systems of FIG. 1, in accordance with at least one embodiment. As a general matter, the method 200 could be performed by any one or any combination of devices, systems, and/or the like that are programmed and/or otherwise arranged to perform the operations described herein. By way of example and not limitation, the method 200 is described herein as being performed by the financial-institution system 114.

At operation 202, the financial-institution system 114 receives what is referred to in the present disclosure as an identity-validation transmission via a real-time-payment platform. In various different embodiments, the identity-validation transmission could be an RTP payment or an RTP message (e.g., a request for payment, a request for information, and/or the like). The identity-validation transmission is received by the financial-institution system 114 in association with a deposit account that is held at the financial institution 116 for the person 126 (the “person-126 account”). In this example, the identity-validation transmission was sent (via the RTP platform 104) by the financial-institution system 106 in association with a deposit account that is held at the financial institution 108 for the person 122 (the “person-122 account”).

In various different examples, RTP payments and/or RTP messages could be sent between individuals, from an individual to an organization (e.g., a company), from an organization to an individual, or between organizations, among other possible sender-and-receiver combinations. Moreover, although this example involves two different financial institutions, both the sending account and the receiving account could be held by the same financial institution. In at least one embodiment, the financial-institution system 114 programmatically transmits an automatic confirmation message back to the financial-institution system 106 upon receipt of the identity-validation transmission.

At operation 204, the financial-institution system 114 validates the identity of the person 122 based at least in part on the identity-validation transmission that was received at operation 202. In various different embodiments, operation 204 could be carried out by any one device or system or any combination of multiple devices and/or systems. In some cases, validating the identity of the person 122 involves transmitting a notification message to a device such as the mobile device 124 with information describing the RTP message or RTP payment that was received at operation 202.

Moreover, in at least one embodiment, RTP payments and/or RTP messages are leveraged by the inclusion therewith of additional information that is useful in validating identity. To that end, the identity-validation transmission (e.g., RTP payment or RTP message) may include a particular code (e.g., password, token, etc.) that may be included in such a notification message for presentation via a user interface of, e.g., the mobile device 124. This code may be used by the person 122 to confirm their identity to the person 126 by, e.g., telling or texting the password or code to the person 126, as examples. In other embodiments, the code may be programmatically checked against a stored code by the financial-institution system 114 and/or the mobile device 124, among other options.

In some embodiments in which the identity-validation transmission is an RTP payment (of, e.g., a nominal amount such as a penny, a few pennies, a fraction of a penny, and/or the like.), the financial-institution system 114 may, in response to receiving that RTP payment, send an equal RTP payment to the person-122 account. In some such embodiments, this may be triggered by a mobile app operating on the mobile device 124, in response to receiving a notification from the financial-institution system 114 regarding the received RTP payment. In other cases, the two RTP payments may be of different amounts. Further permutations and example situations are discussed below.

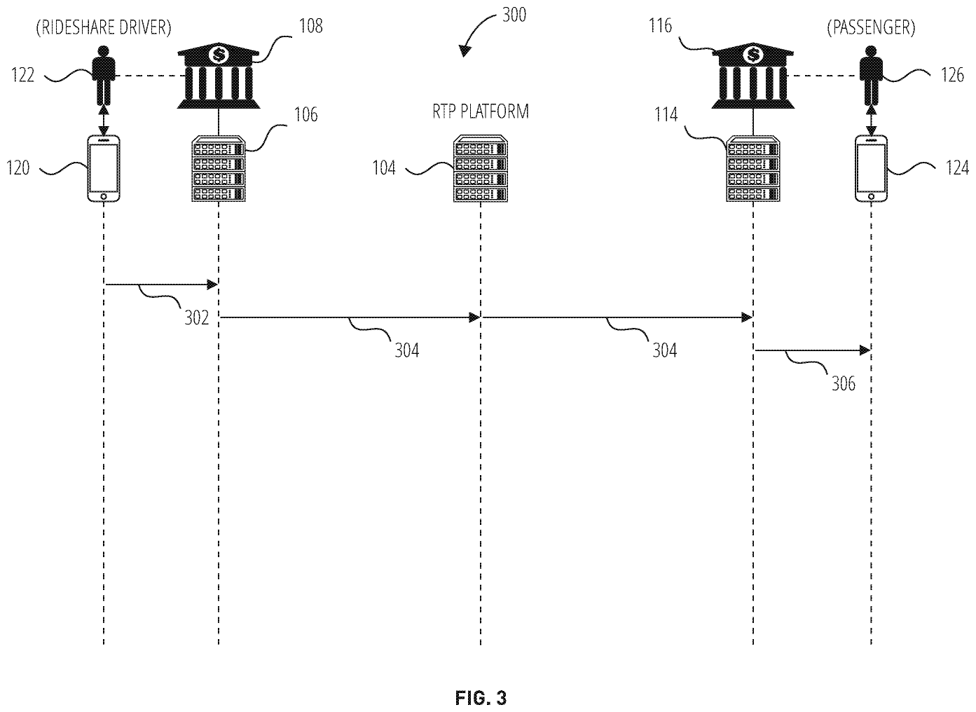

FIG. 3 illustrates a first example message flow involving an example group of entities from the communication context of FIG. 1, in accordance with at least one embodiment. The example message flow 300 that is depicted in FIG. 3 shows an example of how embodiments of the present disclosure can be usefully employed in a context in which validation of identity is helpful in connection with the provision of a service. The example type of service that is discussed here is a rideshare service, though the principles can be applied to any type of service or other context in which validation of identity is desired. In this example, the RTP platform 104 is leveraged by a rideshare-service provider to confirm the identity of a customer that has requested a service, in this case a ride via the rideshare service. Other contexts in which this type of message flow could be employed include validating the identity of a delivery-service customer, a cleaning-service customer, a repair-service customer, and/or the like.

As can be seen in FIG. 3, in this example, the person 122 is a rideshare driver and the person 126 is a rideshare passenger. In one or more of the other examples that are presented herein, the person 122 and/or the person 126 take on different example roles. In this example, upon arriving at the pickup location (e.g., the home address of the person 126), the person 122 may send a command 302 to the financial-institution system 106, instructing that an RTP payment or RTP message be sent to the account of the person 126. A nominal RTP payment 304 of one penny is used in the present example, though an RTP payment or other RTP message (e.g., request for payment, request for information, etc.) could be used instead.

In this example, the driver (person 126) uses an app such as a rideshare-service app or a mobile-banking app to send the command 302 to the financial-institution system 106. In this scenario, the person 126 has previously configured their rideshare-service account to include a token that is representative of their account with the financial institution 116, or instead configured their rideshare-service account to include both the routing number and account number of that account. It is noted that this may be the account that the person 126 uses to pay for rideshare-service rides, or they may use another form of payment (e.g., a credit card) for that purpose. In other examples, the command 302 is sent from the mobile device 120 to the corporate system 128 that holds a deposit account for the company 130, which in such an example could be the rideshare service.

Continuing the present example, the financial-institution system 106, in response to receiving the command 302, sends the RTP payment 304 via the RTP platform 104 to the financial-institution system 114, which is associated with the financial institution 116. It can be seen that the RTP platform 104 receives the RIP payment 304 from the financial-institution system 106 and then forwards the RTP payment 304 on to the financial-institution system 114. Upon receipt of the RTP payment 304, the financial-institution system 114 may send an automatic confirmation of receipt back to the financial-institution system 106 via the RTP platform 104, and the financial-institution system 106 may provide a confirmation message to the mobile device 120. Also responsive to receiving the RTP payment 304, the financial-institution system 114 in this example provides a notification 306 to the mobile device 124, which is the mobile device of the person 126.

In some examples, the sending of the command 302, the RTP payment 304, and the notification 306 may be triggered by the geolocation of the mobile device 120 when, e.g., the driver arrives at or is nearing the predetermined pickup location. Moreover, in some examples, the entire message flow of FIG. 3 could be reversed, in that the person 126 may use the mobile device 124 to transmit a command to the financial-institution system 114, which may then transmit an RTP payment or RTP message to the financial-institution system 106 via the RTP platform 104, and the financial-institution system 106 may in turn notify the mobile device 120. With this notification and the notification 306, the corresponding financial-institution system may send the notification via one or more other networked devices (e.g., a server operated by the rideshare service).

Returning to the example shown in FIG. 3, in one example embodiment, the RTP payment 304 includes a code (e.g., a four-digit number), which the financial-institution system 114 includes in the notification 306 for presentation to the person 122 via the mobile device 124. Upon entering the vehicle or just before entering, the person 126 may repeat the code to the person 122 to validate the identity of the person 126 to the person 122. This same code may be displayed on the mobile device 120 so that the person 122 can know that the two codes match. In another embodiment, the person 126 may tap on a soft button or link on the mobile device 124 to send a notification (via the RTP platform 104 or via a text message or in-app notification) to the mobile device 120, where that notification may include the proper code. In some embodiments, the mobile device 124 may convey the proper code to the mobile device 120 (or other device in the vehicle) via a near-field communication (NFC) message, a Bluetooth message, and/or the like.

In other examples, it may be the person 122 that conveys the code to the person 126 so that the person 126 knows that they are getting in the right vehicle. A response back from the mobile device 124 to the mobile device 120 via the financial-institution system 114, the RTP platform 104, and the financial-institution system 106 could be an RTP payment (in, e.g., the same amount as the RTP payment 304) or an RTP message (e.g., a response to the RTP payment 304), among other possible implementations. In some embodiments, instead of or in addition to a validation code, the RTP payment 304 may include the license-plate number of the vehicle, such that the passenger will feel more comfortable that they are getting into the right vehicle, since that license-plate number would have been conveyed to them via a secure system such as the RTP platform 104.

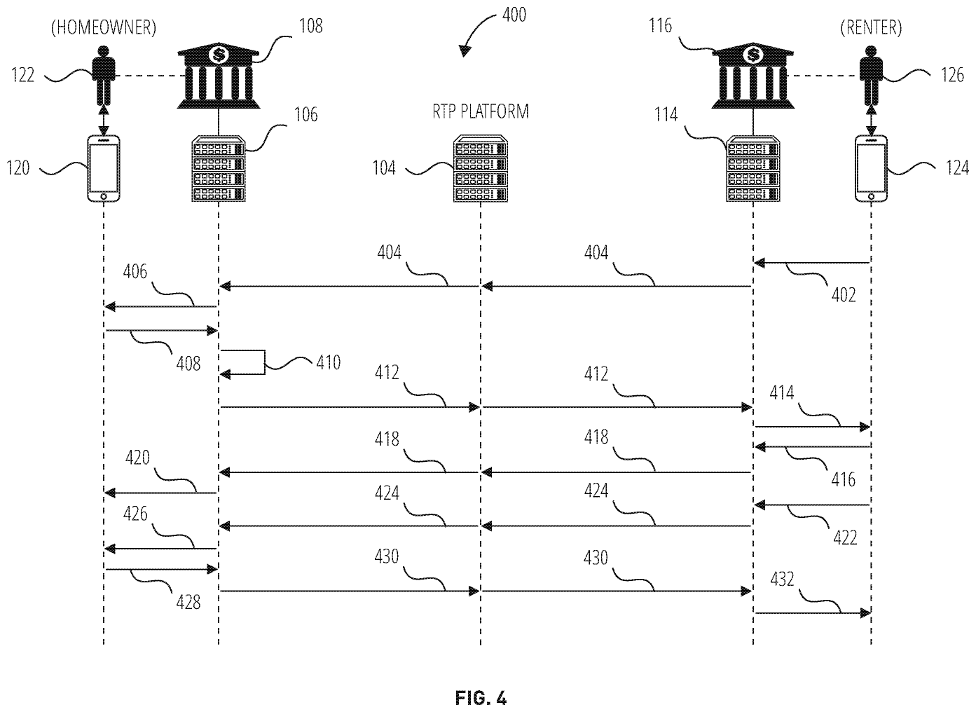

FIG. 4 illustrates a second example message flow involving an example group of entities from the communication context of FIG. 1, in accordance with at least one embodiment. The example message flow 400 takes place in the context of an AirBNB-type situation, with the person 122 being the homeowner in this example context and the person 126 being the prospective renter (and then actual renter). In this example scenario, the person 126 peruses a number of online listings on a home-rental website and then selects a house belonging to the person 122 as being the house that the person 126 wishes to rent (or, initially, at least inquire about renting) for a period of time such as a week, a month, and/or the like.

The aforementioned online listing may include a link or token (e.g., username or email address on a network such as Zelle) or other information associated with the person 122, where that, e.g., link is operable such that, when selected, the mobile device 124 of the person 126 transmits an inquiry command 402 to the financial-institution system 114, which is associated with the financial institution 116, which maintains a deposit account for the person 126. In response to receiving the inquiry command 402, the financial-institution system 114 transmits a request for information 404 (a type of RTP message) to the financial-institution system 106 via the RTP platform 104. The financial-institution system 106 is associated with the financial institution 108, which maintains a deposit account for the person 122.

Upon receiving the request for information 404, which may include information inquiring about the rental and requesting verification of ownership of the listed house by the person 122, the financial-institution system 106 transmits a message notification 406 to the mobile device 120 of the person 122. The message notification 406 may include the aforementioned information that was included in the request for information 404. The request for information 404 may be considered an identity-validation request in the parlance of this disclosure, in that the person 126 triggers the sending of the inquiry command 402 in an effort to validate the identity (and in this case property ownership) of the person 122. An identity-validation request could be an RTP payment or RTP message, as examples. And although validation of direct ownership by a single person is the example that is described here, similar examples could be described in the context of multiple owners of a given property item and/or validation of the identity of one or more proxies for one or more owners, one or more authorized signers associated with one or more owners, and/or the like.

Returning to the present example, the mobile device 120 may prompt the person 122 to approve the sending of a response to the person 126. Upon receiving that approval, the mobile device 120 may send a response command 408 to the financial-institution system 106, which may then perform what is referred to here as an augmentation 410, which is a procedure during which the financial-institution system 106 augments a response intended for viewing by the person 126 with information that buttresses (or undercuts) the assertion implicitly (or explicitly) made by the person 122 that they own the house that is referenced in the online listing.

In an example, the financial-institution system 106 generates an augmented RTP message 412 that includes this information, and then the financial-institution system 106 transmits that generated augmented RTP message 412 to the financial-institution system 114 via the RTP platform 104. Upon receipt of the augmented RTP message 412, the financial-institution system 114 may accordingly transmit a message notification 414 to the mobile device 124, where that message notification 414 includes the substance of the augmented RTP message 412. (In this embodiment and others, it could be the case that a notification merely alerts the corresponding user of the existence of a message or payment, which the corresponding user may then login to see.)

The financial-institution system 106 may include in the augmented RTP message 412 (and thereby in the message notification 414) a binary, Boolean value (i.e., true or false) that indicates whether or not the person 122 owns the house. In other embodiments, the augmentation 410 involves the financial-institution system 106 generating a confidence rating (e.g., star rating) or confidence score (e.g., on a scale of 1-10 or a percentage between 0 and 100, inclusive, etc.) that indicates a level of confidence that the person 122 owns the house. If, for example, the financial institution 108 holds a mortgage for the person 122 on that house, the financial-institution system 106 may include a high confidence score in the augmented RTP message 412. If that is not the case, but the financial-institution system 106 retrieves public records associated with the house that indicate that the person 122 is the owner, the financial-institution system 106 may include a relatively high confidence score that may not be as high as the mortgage-holding example. The confidence score may be impacted by slight mismatches in information (e.g., “Bob” vs. “Robert”).

As part of conducting the augmentation 410, the financial-institution system 106 may request and receive information from one or more other server systems such as the server system 118. The confidence score can be based on multiple sources of information. Some variables that could be taken into account when arriving at a confidence score include a geolocation of an IP address associated with the house and the person 122, whether or not the mobile device 120 is a trusted device, etc.

In the present example, after the receipt of the message notification 414 by the mobile device 124 and the person 126, the person 126 decides that they are satisfied with the information provided and they decide to actually rent the house. Accordingly, the person 126 uses the mobile device 124 to send a payment instruction 416 to the financial-institution system 114, instructing the financial-institution system 114 to make a payment of a deposit on the house to the person 122. In response to receiving the payment instruction 416, the financial-institution system 114 sends an RTP payment 418 in the amount of the deposit to the financial-institution system 106 via the RTP platform 104. In response to receiving the RTP payment 418, the financial-institution system 106 transmits a payment notification 420 to the mobile device 120 to inform the person 122 of the deposit payment.

Further to the present example, some time passes, and the first day of the rental period arrives. The person 126 goes to the rental house and is standing at the front door, ready and wanting to go in. To facilitate entry, the person 126 uses the mobile device 124 to send a payment instruction 422 to the financial-institution system 114, instructing the financial-institution system 114 to make the final payment from the person-126 account to the person-122 account. In response to receiving the payment instruction 422, the financial-institution system 114 transmits an RTP payment 424 to the financial-institution system 106 via the RTP platform 104, where the RTP payment 424 is in the amount of the final payment. In response to receiving the RIP payment 424, the financial-institution system 106 transmits a payment notification 426 to the mobile device 120 of the person 122. That payment notification 426 indicates that the final payment had been made, and that it had been made from the same account that made the RTP payment 418 related to the initial deposit.

Upon receiving the payment notification 426, the person 122 uses the mobile device 120 to transmit an unlock command 428 to the financial-institution system 106, instructing the financial-institution system 106 to send an RTP message 430 (e.g., a payment acknowledgement or reply, request for information, etc.) to the financial-institution system 114 via the RTP platform 104. The financial-institution system 106 does so, and the financial-institution system 114 responsively sends a message notification 432 to the mobile device 124 of the person 126, conveying the substance of the RTP message 430, which conveyed the substance of the unlock command 428. That substance could include a code that the person 126 could use to unlock the door to the house, unlock a key-holding device that contains a key to the house, and/or the like. As another example, that substance could include a password that the person 126 can provide to a rental office, which would match against a saved password, in order to authorize the rental office to provide the person 126 with the key (or lock code, etc.).

Numerous other example workflows could be used as well. In some embodiments, a geolocation of the mobile device 124 is conveyed in the payment instruction 422 and RTP payment 424, and optionally also the payment notification 426, to verify that the person 126 (or at least the mobile device 124) is geographically present at the house, the rental office, and/or the like. In some embodiments, that geolocation automatically triggers the messaging between the mobile device 124 and the mobile device 120 via the financial-institution system 114, the RTP platform 104, and the financial-institution system 106 to result in an automated provision of the lock code to the mobile device 124 and person 126. In other examples, an NFC or Bluetooth (or similar) handshaking communication between the mobile device 124 and a device at the house or rental office, as examples, could trigger that messaging. Other examples are possible as well, as are applications of this approach to other types of property (e.g., ownership of a car, boat, etc.).

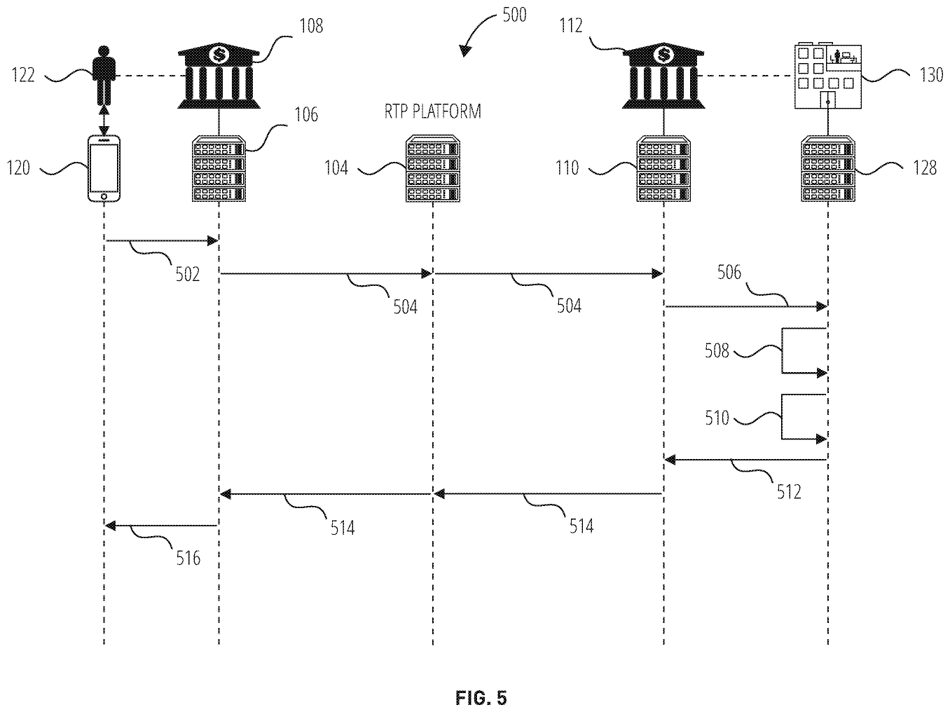

FIG. 5 illustrates a third example message flow involving an example group of entities from the communication context of FIG. 1, in accordance with at least one embodiment. The example message flow 500 shows that embodiments of the present disclosure can be applied to controlled-access situations. The above example involving the rental house was also an example of a controlled-access situation. In the example scenario that is described here in connection with FIG. 5, the controlled-access resource is a particular lab in a particular building. The lab could contain trade-secret-type information, biohazardous materials (related to, e.g., a virus causing a pandemic), and/or the like.

In this example scenario, the person 122 is an authorized worker that has previously been granted access to the lab by the company 130 for whom the person 122 works in this example. As part of this registration process, the person 122 may have communicated information (e.g., a representative token, a routing number and account number, and/or the like) regarding the person-122 account that is held at the financial institution 108. Thus, the corporate system 128 may have stored data that associates the person-122 account with the person 122, with the mobile device 120 of the person 122, and with a level of access that authorizes the person 122 to access the lab in question, which may have a securely networked locking mechanism that secures access to the lab.

When the person 122 approaches the lab, an NFC or other short-range communication (e.g., Bluetooth) may occur between the mobile device 120 and the locking mechanism. Upon sensing proximity to the locking mechanism, the mobile device 120 may responsively send an unlock request 502 to the financial-institution system 106 that is associated with the financial institution 108. Upon receiving the unlock request 502, the financial-institution system 106 may responsively transmit an RTP message 504 to the financial-institution system 110 via the RIP platform 104. The RTP message 504 could be a request for information, as an example. In other embodiments, a nominal payment could be used, and perhaps trigger an equal and opposite nominal payment back to the person-122 account. The financial-institution system 110 is associated with the financial institution 112, which maintains a deposit account (the “company-130 account”) on behalf of the company 130, which operates the corporate system 128.

Upon receipt of the RTP message 504, the financial-institution system 110 may responsively send an unlock-request notification 506 to the corporate system 128, which, upon receiving the unlock-request notification 506, may responsively conduct an authorization procedure 508 to validate that the mobile device 120 and the person-122 account are associated with the person 122, who is an authorized user of the lab. The mobile device 120 could have been provisioned with a code (e.g., a changing code) that the mobile device 120 may include in the unlock request 502 for inclusion in the resulting RTP message 504 and unlock-request notification 506. The corporate system 128 may validate that code as part of conducting the authorization procedure 508 to approve the person 122 for entry into the lab.

Upon concluding from the authorization procedure 508 that the person 122 is authorized, the corporate system 128 may conduct an unlocking procedure 510 to grant access to the lab to the person 122. In some cases, the unlocking procedure 510 may involve actually unlocking the locking mechanism that prevents access to the lab. In other cases, the unlocking procedure 510 may involve formatting a secure message for sending back to the mobile device 120 via the RTP rail, where that secure message contains, e.g., a code that the person 122 can enter into a keypad to open the locking mechanism. In other cases, the mobile device 120 may wirelessly transmit the authorization code to the locking mechanism in order to gain access to the lab. Other message flows and approaches could be used as well.

The corporate system 128 may send an unlock notification 512 to the financial-institution system 110 in order to trigger the sending of an RTP message 514 to the financial-institution system 106 via the RTP platform 104. Upon receipt of the RTP message 514, the financial-institution system 106 may format and transmit an unlock notification 516 to the mobile device 120. That unlock notification 516 could include an access code to the lab as discussed above, or could simply be a notification that access is being granted, among other possibilities. Instead of a lab, other access-controlled resources could be involved, such as building security systems, hotel rooms, storage lockers, storage units, lockboxes, etc. In other examples, the access controls could be with respect to one or more digital resources such as protected datastores, servers, webpages, email accounts, social-media accounts, and/or the like.

Various different embodiments and example contexts and use cases are described herein, and others will occur to those of skill in the relevant arts having the benefit of the present disclosure. One additional example context in which embodiments of the present disclosure could be employed is in connection with point-of-sale transactions. Indeed, the real-time nature of RTP platforms can be used to effect validation of identity for purposes of fraud prevention in connection with point-of-sale transactions. The transmission of one or more RTP payments and/or one or more RTP messages could be used to verify that a person using a given transaction card (e.g., a debit card) is actually the person for whom the corresponding financial institution is maintaining a deposit account that is connected to that transaction card (or wallet app and/or the like). An RTP exchange triggered by a point-of-sale device between a deposit account associated with the business and the deposit account associated with the customer could return to the business a picture of the customer, a password that the customer would need to know to complete the transaction, and/or the like.

FIG. 6 illustrates an example network arrangement 600 that may be employed by one or more of the example financial institutions of FIG. 1, in accordance with at least one embodiment. In particular, any one or more of the financial institution 108, the financial institution 112, and the financial institution 116 may implement a network arrangement such as the example network arrangement 600 that is shown in FIG. 6. That being said, the network arrangement 600 is provided here by way of example and not limitation, as a network arrangement of a given financial institution could have different numbers, types, and/or arrangements of devices, systems, networks, and/or the like. Moreover, the present disclosure is not limited in applicability to financial institutions, as embodiments of the present disclosure could be applied in the context of one or more different types of organizations. Purely by way of example and not limitation, where applicable, the example network arrangement 600 of FIG. 6 is described below in connection with the financial institution 116 as a representative example.

In the example network arrangement 600, a number of different devices, systems, and the like are communicatively connected via respective communication links with the network 102, which is described above in connection with FIG. 1, and thus is not described again in detail here. These devices, systems, and the like include an ATM 602, an ATM 604, an ATM 606, a laptop computer 608, a laptop computer 610, a mobile device 612, a server system 614, and a server system 616. In the depicted example, the server system 616 is also communicatively connected with a network 618. Also connected with the network 618 are a desktop computer 620, a laptop computer 622, and a database system 624. In at least one embodiment, only a subset of the devices, systems, and networks that are depicted in FIG. 6 are actually part of and managed by the aforementioned example financial institution 116. An example such subset includes the ATM 602, the ATM 604, the ATM 606, the server system 616, the network 618, the desktop computer 620, the laptop computer 622, and the database system 624.

The network 618 could be a private IP network operated by the financial institution 116. In addition to other functions, the server system 616 could provide NAS functions, gateway services, firewall protections, and/or the like for the network 618 with respect to the network 102. Any of the devices in communication with the network 102, such as one or more of the ATM 602, the ATM 604, the ATM 606, the laptop computer 608, the laptop computer 610, the mobile device 612, and the server system 614, could communicate via the network 102 and the server system 616 with one or more entities on the network 618, in some cases doing so via a VPN and/or another type of secure-tunneling communication protocol, connection, and/or the like.

Any one or more of the ATM 602, the ATM 604, and the ATM 606 could be an ATM that provides conventional ATM-type services such as cash withdrawal, cash deposit, check deposit, account transfers, balance inquiries, bill pay, and/or the like. Users may access any one or more of the ATM 602, the ATM 604, and the ATM 606 using a secure card, a mobile device such as the mobile device 612, and/or the like, along with security credentials such as a personal identification number (PIN), a password, a passcode, and/or the like. In some implementations, biometric authentication is used by the ATM 602, the ATM 604, and/or the ATM 606, either via an interface of the ATM itself or via an interface of a device such as the mobile device 612.

In an embodiment, the server system 616 hosts a web-server application that provides an online-banking portal that can be accessed by devices such as the laptop computer 608, the laptop computer 610, the mobile device 612, and/or the like. In this way, in some embodiments, the server system 616 corresponds to the financial-institution system 114 that is associated with the financial institution 116. As another example, a mobile-banking app could be downloaded by, installed on, and executed by one or more mobile devices such as the mobile device 612, which may correspond to the mobile device 124 in FIG. 1, to provide a user (e.g., the person 126) with access to one or more accounts managed by the financial institution 116. Desktop applications are used in some embodiments to access and manage one or more financial accounts.

Moreover, although pictured as a data-storage container, the database system 624 could include in addition to one or more data-storage containers, devices, units, and/or the like—one or more database servers that operate to serve requests to carry out database operations with respect to the database system 624, where such database operations could include retrieving data, extracting data, modifying data, updating data, removing data, and/or the like. Moreover, although the database system 624 is shown as being at a single network location in the network arrangement 600, the database system 624 could include multiple different servers, data silos, and/or the like in multiple different geographic and/or network-topology locations. In at least one embodiment, the database system 624 provides a database-system backend for one or more applications such as an online-banking portal, an online-banking mobile app, an online-banking desktop application, and/or the like.

FIG. 7 is a diagrammatic representation of a computer system 700 within which instructions 712 (e.g., software, a program, an application, an applet, an app, and/or other executable code) for causing the computer system 700 to perform any one or more of the methodologies discussed herein may be executed. For example, the instructions 712 may cause the computer system 700 to execute any one or more of the methods described herein. The instructions 712 transform the general, non-programmed computer system 700 into a particular computer system 700 programmed to carry out the described and illustrated functions in the manner described. The computer system 700 may operate as a standalone device or may be coupled (e.g., networked) to other machines. In a networked deployment, the computer system 700 may operate in the capacity of a server machine or a client machine in a server-client network environment, or as a peer machine in a peer-to-peer (or distributed) network environment.

The computer system 700 may be or include, but is limited to, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, and/or any other machine capable of executing the instructions 712, sequentially or otherwise, that specify actions to be taken by the computer system 700. Further, while only a single computer system 700 is illustrated, the term “machine” shall also be taken to include a collection of machines that individually or jointly execute the instructions 712 to perform any one or more of the methodologies discussed herein.

The computer system 700 may include processors 702, memory 704, and I/O components 706, which may be configured to communicate with each other via a bus 744. In an example embodiment, the processors 702 (e.g., a central processing unit (CPU), a Reduced Instruction Set Computing (RISC) processor, a Complex Instruction Set Computing (CISC) processor, a graphics processing unit (GPU), a digital signal processor (DSP), an application-specific integrated circuit (ASIC), a radio-frequency integrated circuit (RFIC), another processor, and/or any suitable combination thereof) may include, for example, a processor 708 and a processor 710 that execute the instructions 712. The term “processor” is intended to include multi-core processors that may include two or more independent processors (sometimes referred to as “cores”) that may execute instructions contemporaneously. Although FIG. 7 shows multiple processors 702, the computer system 700 may include a single processor with a single core, a single processor with multiple cores (e.g., a multi-core processor), multiple processors with a single core, multiple processors with multiples cores, or any combination thereof.

The memory 704 includes a main memory 714, a static memory 716, and a storage unit 718, each of which is accessible to the processors 702 via the bus 744. The memory 704, the static memory 716, and/or the storage unit 718 may store the instructions 712 executable for performing any one or more of the methodologies or functions described herein. The instructions 712 may also or instead reside completely or partially within the main memory 714, within the static memory 716, within machine-readable medium 720 within the storage unit 718, within at least one of the processors 702 (e.g., within a cache memory of a given one of the processors 702), and/or any suitable combination thereof, during execution thereof by the computer system 700.

The I/O components 706 may include a wide variety of components to receive input, produce and/or provide output, transmit information, exchange information, capture measurements, and/or the like. The specific I/O components 706 that are included in a particular instance of the computer system 700 will depend on the type of machine. For example, portable machines such as mobile phones may include a touch input device or other such input mechanisms, while a headless server machine may not include such a touch input device. It will be appreciated that the I/O components 706 may include many other components that are not shown in FIG. 7.

In various example embodiments, the I/O components 706 may include output components 730 and input components 732. The output components 730 may include visual components (e.g., a display such as a plasma display panel (PDP), a light emitting diode (LED) display, a liquid crystal display (LCD), a projector, and/or a cathode ray tube (CRT)), acoustic components (e.g., speakers), haptic components (e.g., a vibratory motor, resistance mechanisms), other signal generators, and so forth. The input components 732 may include alphanumeric input components (e.g., a keyboard, a touchscreen configured to receive alphanumeric input, a photo-optical keyboard, and/or other alphanumeric input components), point-based input components (e.g., a mouse, a touchpad, a trackball, a joystick, a motion sensor, and/or one or more other pointing instruments), tactile input components (e.g., a physical button, a touchscreen that is responsive to location and/or force of touches or touch gestures, and/or one or more other tactile input components), audio input components (e.g., a microphone), and/or the like.

In further example embodiments, the I/O components 706 may include biometric components 734, motion components 736, environmental components 738, and/or position components 740, among a wide array of other components. The biometric components 734 may include components to detect expressions (e.g., hand expressions, facial expressions, vocal expressions, body gestures, eye tracking, and/or the like), measure biosignals (e.g., blood pressure, heart rate, body temperature, perspiration, brain waves, and/or the like), identify a person (by way of, e.g., voice identification, retinal identification, facial identification, fingerprint identification, and/or electroencephalogram-based identification), and/or the like. The motion components 736 may include acceleration-sensing components (e.g., an accelerometer), gravitation-sensing components, rotation-sensing components (e.g., a gyroscope), etc.

The environmental components 738 may include, for example, illumination-sensing components (e.g., a photometer), temperature-sensing components (e.g., one or more thermometers), humidity-sensing components, pressure-sensing components (e.g., a barometer), acoustic-sensing components (e.g., one or more microphones), proximity-sensing components (e.g., infrared sensors that detect nearby objects), gas-sensing components (e.g., gas-detection sensors to detection concentrations of hazardous gases for safety and/or to measure pollutants in the atmosphere), and/or other components that may provide indications, measurements, signals, and/or the like that correspond to a surrounding physical environment. The position components 740 may include location-sensing components (e.g., a global positioning system (GPS) receiver), altitude-sensing components (e.g., altimeters and/or barometers that detect air pressure from which altitude may be derived), orientation-sensing components (e.g., magnetometers), and/or the like.

Communication may be implemented using a wide variety of technologies. The I/O components 706 may further include communication components 742 operable to communicatively couple the computer system 700 to a network 722 and/or devices 724 via a coupling 726 and/or a coupling 728, respectively. For example, the communication components 742 may include a network-interface component or another suitable device to interface with the network 722. In further examples, the communication components 742 may include wired-communication components, wireless-communication components, cellular-communication components, Near Field Communication (NFC) components, Bluetooth (e.g., Bluetooth Low Energy) components, Wi-Fi components, and/or other communication components to provide communication via one or more other modalities. The devices 724 may include one or more other machines and/or any of a wide variety of peripheral devices (e.g., a peripheral device coupled via a universal serial bus (USB) connection).

Moreover, the communication components 742 may detect identifiers or include components operable to detect identifiers. For example, the communication components 742 may include radio frequency identification (RFID) tag reader components, NFC-smart-tag detection components, optical-reader components (e.g., an optical sensor to detect one-dimensional bar codes such as Universal Product Code (UPC) bar codes, multi-dimensional bar codes such as Quick Response (QR) codes, Aztec codes, Data Matrix, Dataglyph, MaxiCode, PDF417, Ultra Code, UCC RSS-2D bar codes, and/or other optical codes), and/or acoustic-detection components (e.g., microphones to identify tagged audio signals). In addition, a variety of information may be derived via the communication components 742, such as location via Internet Protocol (IP) geolocation, location via Wi-Fi signal triangulation, location via detecting an NFC beacon signal that may indicate a particular location, and/or the like.

One or more of the various memories (e.g., the memory 704, the main memory 714, the static memory 716, and/or the (e.g., cache) memory of one or more of the processors 702) and/or the storage unit 718 may store one or more sets of instructions (e.g., software) and/or data structures embodying or used by any one or more of the methodologies or functions described herein. These instructions (e.g., the instructions 712), when executed by one or more of the processors 702, cause various operations to implement various embodiments of the present disclosure.

The instructions 712 may be transmitted or received over the network 722, using a transmission medium, via a network-interface device (e.g., a network-interface component included in the communication components 742) and using any one of a number of well-known transfer protocols (e.g., the Session Initiation Protocol (SIP), the hypertext transfer protocol (HTTP), and/or the like). Similarly, the instructions 712 may be transmitted or received using a transmission medium via the coupling 728 (e.g., a peer-to-peer coupling) to the devices 724.

FIG. 8 is a block diagram 800 illustrating a software architecture 802, which can be installed on any one or more of the devices described herein. For example, the software architecture 802 could be installed on any device or system that is arranged similar to the computer system 700 of FIG. 7. The software architecture 802 is supported by hardware such as a machine 804 that includes processors 806, memory 808, and I/O components 810. In this example, the software architecture 802 can be conceptualized as a stack of layers, where each layer provides a particular functionality. The software architecture 802 includes layers such an operating system 812, libraries 814, frameworks 816, and applications 818. Operationally, using one or more application programming interfaces (APIs), the applications 818 invoke API calls 820 through the software stack and receive messages 822 in response to the API calls 820.

The operating system 812 manages hardware resources and provides common services. The operating system 812 includes, for example, a kernel 824, services 826, and drivers 828. The kernel 824 acts as an abstraction layer between the hardware and the other software layers. For example, the kernel 824 may provide memory management, processor management (e.g., scheduling), component management, networking, and/or security settings, in some cases among other functionality. The services 826 can provide other common services for the other software layers. The drivers 828 are responsible for controlling or interfacing with the underlying hardware. For instance, the drivers 828 can include display drivers, camera drivers, Bluetooth or Bluetooth Low Energy drivers, flash memory drivers, serial communication drivers (e.g., USB drivers), Wi-Fi drivers, audio drivers, power management drivers, and/or the like.

The libraries 814 provide a low-level common infrastructure used by the applications 818. The libraries 814 can include system libraries 830 (e.g., a C standard library) that provide functions such as memory-allocation functions, string-manipulation functions, mathematic functions, and/or the like. In addition, the libraries 814 can include API libraries 832 such as media libraries (e.g., libraries to support presentation and/or manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), Portable Network Graphics (PNG), and/or the like), graphics libraries (e.g., an OpenGL framework used to render in two dimensions (2D) and three dimensions (3D) in graphic content on a display), database libraries (e.g., SQLite to provide various relational-database functions), web libraries (e.g., WebKit to provide web-browsing functionality), and/or the like. The libraries 814 can also include a wide variety of other libraries 834 to provide many other APIs to the applications 818.

The frameworks 816 may provide a high-level common infrastructure that is used by the applications 818. For example, the frameworks 816 may provide various graphical user interface (GUI) functions, high-level resource management, high-level location services, and/or the like. The frameworks 816 can provide a broad spectrum of other APIs that can be used by the applications 818, some of which may be specific to a particular operating system or platform.

Purely as representative examples, the applications 818 may include a home application 836, a contacts application 838, a browser application 840, a book-reader application 842, a location application 844, a media application 846, a messaging application 848, a game application 850, and/or a broad assortment of other applications generically represented in FIG. 8 as a third-party application 852. The applications 818 are programs that execute functions defined in the programs. Various programming languages can be employed to create one or more of the applications 818, structured in a variety of manners, such as object-oriented programming languages (e.g., Objective-C, Java, C++, etc.), procedural programming languages (e.g., C, assembly language, etc.), and/or the like. In a specific example, the third-party application 852 (e.g., an application developed using the ANDROID™ or IOS™ software development kit (SDK) by an entity other than the vendor of the particular platform) could be mobile software running on a mobile operating system such as IOS™, ANDROID™, WINDOWS® Phone, and/or the like. In this example, the third-party application 852 can invoke the API calls 820 provided by the operating system 812 to facilitate functionality described herein.

Below is a listing of some examples of embodiments.

Example 1 is a method that includes receiving, by a financial-institution system that includes at least one hardware processor, an identity-validation transmission via a real-time-payment platform, the identity-validation transmission being received in association with a first deposit account that is held at a financial institution that is associated with the financial-institution system, the identity-validation transmission having been sent via the real-time-payment platform in association with a second deposit account; and validating an identity of an account holder of the second deposit account based at least in part on the identity-validation transmission.

Example 2 is the method of Example 1, where the identity-validation transmission includes a real-time-platform payment.

Example 3 is the method of Example 2, further including sending a second real-time-platform payment from the first deposit account to the second deposit account via the real-time-payment platform, the second real-time-platform payment being a same monetary amount as the real-time-platform payment.

Example 4 is the method of Example 1, where the identity-validation transmission includes a real-time-platform message.

Example 5 is the method of any of the Examples 1-4, where the second deposit account is held at a second financial institution.

Example 6 is the method of any of the Examples 1-4, where the second deposit account is also held at the financial institution.

Example 7 is the method of any of the Examples 1-6, where the identity-validation transmission includes an identity-validation code; and validating the identity of the account holder of the second deposit account based at least in part on the identity-validation transmission includes validating the identity-validation code.

Example 8 is the method of any of the Examples 1-7, further including sending an identity-validation-request transmission from the first deposit account to the second deposit account via the real-time-payment platform, where the identity-validation transmission is responsive to the identity-validation-request transmission.

Example 9 is the method of Example 8, where the identity-validation-request transmission includes a real-time-platform payment.

Example 10 is the method of Example 8, where the identity-validation-request transmission includes a real-time-platform message.

Example 11 is the method of any of the Examples 1-10, further including receiving, prior to receiving the identity-validation transmission, an earlier real-time-payment-platform transmission in association with the first deposit account via the real-time-payment platform, the earlier real-time-payment-platform transmission having been sent in association with the second deposit account, where validating the identity of the account holder of the second deposit account based at least in part on the identity-validation transmission includes validating that both the earlier real-time-payment-platform transmission and the identity-validation transmission were sent in association with the same deposit account. The earlier real-time-payment-platform transmission could include a real-time-platform payment and/or a real-time-platform message.

Example 12 is the method of any of the Examples 1-11, further including granting access to a controlled resource responsive to validating the identity of the account holder of the second deposit account.

Example 13 is the method of Example 12, where granting access to the controlled resource includes providing access-granting information to one or both of the account holder of the second deposit account and a device that is associated with the account holder of the second deposit account.

Example 14 is the method of Example 12, where granting access to the controlled resource includes unlocking a locking mechanism that was preventing access to the controlled resource.

Example 15 is the method of any of the Examples 1-14, further including generating a response message that is responsive to the identity-validation transmission, the response message including identity-validation information for validating an identity of the account holder of the first deposit account; and sending the response message from the first deposit account to the second deposit account via the real-time-payment platform.

Example 16 is the method of Example 15, wherein generating the response message includes augmenting the response message with ownership-validation information that validates ownership by the account holder of the first deposit account of a property item.

Example 17 is the method of Example 16, further including retrieving at least some of the ownership-validation information from a third-party server system.

Example 18 is the method of Example 16, wherein the ownership-validation information includes a confidence score.

Example 19 is a financial-institution system that includes at least one hardware processor; and one or more non-transitory computer readable storage media containing instructions executable by the at least one hardware processor for causing the at least one hardware processor to perform operations including receiving an identity-validation transmission via a real-time-payment platform, the identity-validation transmission being received in association with a first deposit account that is held at a financial institution that is associated with the financial-institution system, the identity-validation transmission having been sent via the real-time-payment platform in association with a second deposit account; and validating an identity of an account holder of the second deposit account based at least in part on the identity-validation transmission.

Example 20 is one or more non-transitory computer readable storage media containing instructions executable by at least one hardware processor for causing the at least one hardware processor to perform operations including receiving, by a financial-institution system that includes the at least one hardware processor, an identity-validation transmission via a real-time-payment platform, the identity-validation transmission being received in association with a first deposit account that is held at a financial institution that is associated with the financial-institution system, the identity-validation transmission having been sent via the real-time-payment platform in association with a second deposit account; and validating an identity of an account holder of the second deposit account based at least in part on the identity-validation transmission.

To promote an understanding of the principles of the present disclosure, various embodiments are illustrated in the drawings. The embodiments disclosed herein are not intended to be exhaustive or to limit the present disclosure to the precise forms that are disclosed in the above detailed description. Rather, the described embodiments have been selected so that others skilled in the art may utilize their teachings. Accordingly, no limitation of the scope of the present disclosure is thereby intended.

In any instances in this disclosure, including in the claims, in which numeric modifiers such as first, second, and third are used in reference to components, data (e.g., values, identifiers, parameters, and/or the like), and/or any other elements, such use of such modifiers is not intended to denote or dictate any specific or required order of the elements that are referenced in this manner. Rather, any such use of such modifiers is intended to assist the reader in distinguishing elements from one another, and should not be interpreted as insisting upon any particular order or carrying any other significance, unless such an order or other significance is clearly and affirmatively explained herein.

Moreover, consistent with the fact that the entities and arrangements that are described herein, including the entities and arrangements that are depicted in and described in connection with the drawings, are presented as examples and not by way of limitation, any and all statements or other indications as to what a particular drawing “depicts,” what a particular element or entity in a particular drawing or otherwise mentioned in this disclosure “is” or “has,” and any and all similar statements that are not explicitly self-qualifying by way of a clause such as “In at least one embodiment,” and that could therefore be read in isolation and out of context as absolute and thus as a limitation on all embodiments, can only properly be read as being constructively qualified by such a clause. It is for reasons akin to brevity and clarity of presentation that this implied qualifying clause is not repeated ad museum in the present disclosure.

What is claimed is:

1. A method comprising:
receiving, by a financial-institution system comprising at least one hardware processor, an identity-validation transmission via a real-time-payment platform, the identity-validation transmission being received in association with a first deposit account that is held at a financial institution that is associated with the financial-institution system, the identity-validation transmission having been sent via the real-time-payment platform in association with a second deposit account; and
validating an identity of an account holder of the second deposit account based at least in part on the identity-validation transmission.

2. The method of claim 1, wherein the identity-validation transmission comprises a real-time-platform payment.

3. The method of claim 2, further comprising sending a second real-time-platform payment from the first deposit account to the second deposit account via the real-time-payment platform, the second real-time-platform payment being a same monetary amount as the real-time-platform payment.

4. The method of claim 1, wherein the identity-validation transmission comprises a real-time-platform message.

5. The method of claim 1, wherein the second deposit account is held at a second financial institution.

6. The method of claim 1, wherein the second deposit account is also held at the financial institution.

7. The method of claim 1, wherein:
the identity-validation transmission comprises an identity-validation code; and
validating the identity of the account holder of the second deposit account based at least in part on the identity-validation transmission comprises validating the identity-validation code.

8. The method of claim 1, further comprising:
sending an identity-validation-request transmission from the first deposit account to the second deposit account via the real-time-payment platform,
wherein the identity-validation transmission is responsive to the identity-validation-request transmission.

9. The method of claim 8, wherein the identity-validation-request transmission comprises a real-time-platform payment.

10. The method of claim 8, wherein the identity-validation-request transmission comprises a real-time-platform message.

11. The method of claim 1, further comprising:
receiving, prior to receiving the identity-validation transmission, an earlier real-time-payment-platform transmission in association with the first deposit account via the real-time-payment platform, the earlier real-time-payment-platform transmission having been sent in association with the second deposit account,
wherein validating the identity of the account holder of the second deposit account based at least in part on the identity-validation transmission comprises validating that both the earlier real-time-payment-platform transmission and the identity-validation transmission were sent in association with the same deposit account.

12. The method of claim 1, further comprising granting access to a controlled resource responsive to validating the identity of the account holder of the second deposit account.

13. The method of claim 12, wherein granting access to the controlled resource comprises providing access-granting information to one or both of the account holder of the second deposit account and a device that is associated with the account holder of the second deposit account.

14. The method of claim 12, wherein granting access to the controlled resource comprises unlocking a locking mechanism that was preventing access to the controlled resource.

15. The method of claim 1, further comprising:
generating a response message that is responsive to the identity-validation transmission, the response message comprising identity-validation information for validating an identity of the account holder of the first deposit account; and
sending the response message from the first deposit account to the second deposit account via the real-time-payment platform.

16. The method of claim 15, wherein generating the response message comprises augmenting the response message with ownership-validation information that validates ownership by the account holder of the first deposit account of a property item.

17. The method of claim 16, further comprising retrieving at least some of the ownership-validation information from a third-party server system.

18. The method of claim 16, wherein the ownership-validation information comprises a confidence score.

19. A financial-institution system comprising:
at least one hardware processor; and
one or more non-transitory computer readable storage media containing instructions executable by the at least one hardware processor for causing the at least one hardware processor to perform operations comprising:
receiving an identity-validation transmission via a real-time-payment platform, the identity-validation transmission being received in association with a first deposit account that is held at a financial institution that is associated with the financial-institution system, the identity-validation transmission having been sent via the real-time-payment platform in association with a second deposit account; and
validating an identity of an account holder of the second deposit account based at least in part on the identity-validation transmission.

20. One or more non-transitory computer readable storage media containing instructions executable by at least one hardware processor for causing the at least one hardware processor to perform operations comprising:
receiving, by a financial-institution system comprising the at least one hardware processor, an identity-validation transmission via a real-time-payment platform, the identity-validation transmission being received in association with a first deposit account that is held at a financial institution that is associated with the financial-institution system, the identity-validation transmission having been sent via the real-time-payment platform in association with a second deposit account; and
validating an identity of an account holder of the second deposit account based at least in part on the identity-validation transmission.
